(19) United States
(12) Patent Application Publication
(10) Pub. No.: US 2022/0016773 A1
(43) Pub. Date: Jan. 20, 2022

(54) CONTROL APPARATUS, CONTROL METHOD, AND PROGRAM

(71) Applicant: SONY GROUP CORPORATION, TOKYO (JP)

(72) Inventors: RYOICHI TSUZAKI, TOKYO (JP); MASAYA KINOSHITA, TOKYO (JP); YASUHISA KAMIKAWA, TOKYO (JP); YUKI ITOTANI, TOKYO (JP)

(21) Appl. No.: 17/295,081

(22) PCT Filed: Oct. 30, 2019
(86) PCT No.: PCT/JP2019/042479

§ 371 Date: May 19, 2021

(30) Foreign Application Priority Data
Nov. 27, 2018 (JP) 2018-221556

(51) Int. Cl. B25J 9/16; B25J 13/08; B25J 19/02

(52) U.S. Cl. CPC B25J 9/1664; B25J 19/021; B25J 9/1697; B25J 13/08

(57) ABSTRACT

A control apparatus includes determination unit that determines whether a related element is included in environmental information on the basis of a position and a shape of the related element, and an environmental information control unit that controls a mode of acquisition or use of the environmental information on the basis of determination performed by the determination unit.

### FIELD

The present disclosure relates to a control apparatus, a control method, and a program.

### BACKGROUND

In general, a robot apparatus acquires environmental information on surroundings by a sensor unit, controls a movement unit on the basis of the acquired environmental information, and performs movement appropriate for the surroundings.

However, when the sensor unit observes the movement unit itself of the robot apparatus, the robot apparatus may recognize the movement unit that is a part of the robot apparatus as an obstacle present in the surroundings, and fail to appropriately control the movement unit.

To cope with this, for example, Patent Literature 1 listed below discloses a technology for, in the robot apparatus, identifying a signal that is output by observation of the movement unit of the robot apparatus and disabling the identified signal.

### CITATION LIST

### Patent Literature

Patent Literature 1: Japanese Laid-open Patent Publication No. 2009-255264

### SUMMARY

### Technical Problem

However, in the technology described in Patent Literature 1 above, an amount of calculations for identifying a signal corresponding to the movement unit from among signals detected by the sensor unit increases. Therefore, in the technology described in Patent Literature 1 above, a large burden is imposed on an arithmetic unit of the robot apparatus.

To cope with this, there is a need for a technology capable of optimally controlling a robot apparatus with a simpler configuration even if an element related to the robot apparatus is included in environmental information.

### Solution to Problem

According to the present disclosure, a control apparatus is provided that includes: a determination unit that determines whether a related element is included in environmental information on the basis of a position and a shape of the related element; and an environmental information control unit that controls a mode of acquisition or use of the environmental information on the basis of determination performed by the determination unit.

Moreover, according to the present disclosure, a control method implemented by an arithmetic device is provided that includes: determining whether a related element is included in environmental information on the basis of a position and a shape of the related element; and controlling a mode of acquisition or use of the environmental information on the basis of determination at the determining.

Moreover, according to the present disclosure, a program is provided that causes a computer to function as: a determination unit that determines whether a related element is included in environmental information on the basis of a position and a shape of the related element; and an environmental information control unit that controls a mode of acquisition or use of the environmental information on the basis of determination performed by the determination unit.

### BRIEF DESCRIPTION OF DRAWINGS

FIG. 1A is a schematic diagram illustrating an example of a robot apparatus to which the technology according to the present disclosure is applicable.

FIG. 1B is a schematic diagram illustrating another example of the robot apparatus to which the technology according to the present disclosure is applicable.

FIG. 2 is a schematic diagram illustrating still another example of the robot apparatus to which the technology according to the present disclosure is applicable.

FIG. 3 is a block diagram for explaining a functional configuration of a control apparatus according to a first embodiment of the present disclosure.

FIG. 4 is a flowchart for explaining the flow of a first operation example of the control apparatus according to the first embodiment.

FIG. 5 is a flowchart for explaining the flow of a second operation example of the control apparatus according to the first embodiment.

FIG. 6 is a flowchart for explaining the flow of a third operation example of the control apparatus according to the first embodiment.

FIG. 7 is a flowchart for explaining the flow of a fourth operation example of the control apparatus according to the first embodiment.

FIG. 8 is a flowchart for explaining the flow of a fifth operation example of the control apparatus according to the first embodiment.

FIG. 9 is a flowchart for explaining the flow of a sixth operation example of the control apparatus according to the first embodiment.

FIG. 10 is a block diagram for explaining a functional configuration of a control apparatus according to a second embodiment of the present disclosure.

FIG. 11A is an explanatory diagram illustrating an example of a predetermined pattern for identifying a region corresponding to a related element from environmental information in the second embodiment.

FIG. 11B is an explanatory diagram illustrating another example of the predetermined pattern for identifying the region corresponding to the related element from environmental information in the second embodiment.

FIG. 12 is a flowchart for explaining the flow of an operation example of the control apparatus according to the second embodiment.

FIG. 13 is a block diagram illustrating a hardware configuration example of the control apparatus according to one embodiment of the present disclosure.

### DESCRIPTION OF EMBODIMENTS

Preferred embodiments of the present disclosure will be described in detail below with reference to the accompanying drawings. Meanwhile, in the present specification and drawings, structural elements having substantially the same functions and configurations are denoted by the same reference symbols, and repeated explanation thereof will be omitted.

In addition, hereinafter, explanation will be given in the following order.

1. Target to which technology according to present disclosure is applicable

2. First Embodiment
2.1. Configuration example
2.2. Operation example

3. Second Embodiment
3.1. Configuration example
3.2. Operation example

4. Hardware configuration example

5. Note

### 1. Target to which Technology According to Present Disclosure is Applicable

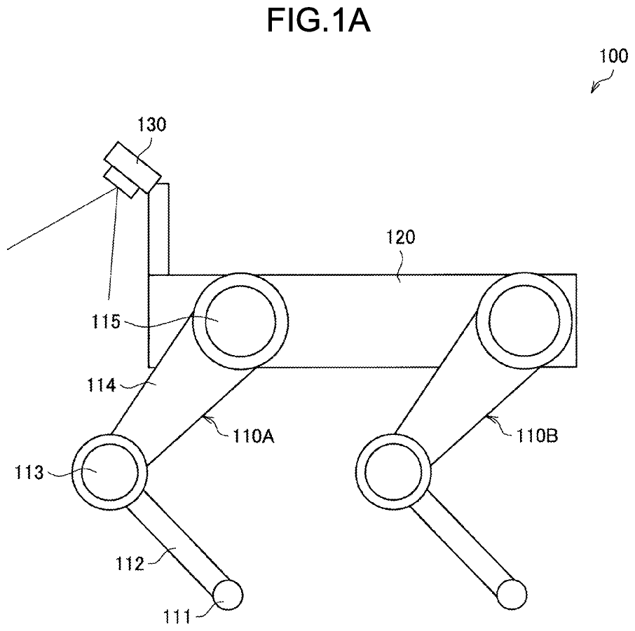

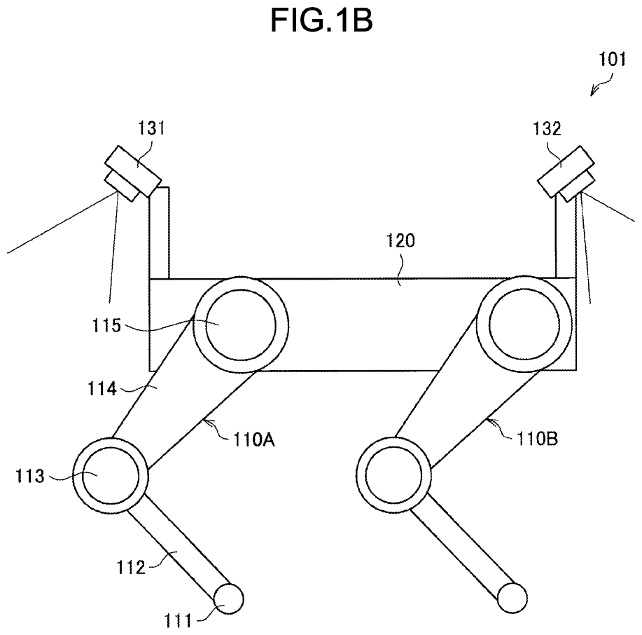

First, with reference to FIG. 1A to FIG. 2, a target to which the technology according to the present disclosure is applicable will be described. FIG. 1A to FIG. 2 are schematic diagrams illustrating an example of a robot apparatus to which the technology according to the present disclosure is applicable.

As illustrated in FIG. 1A, a robot apparatus 100 to which the technology according to the present disclosure is applicable includes a body unit 120, a sensor 130, and a plurality of leg units 110A and 110B (hereinafter, they are collectively referred to as a leg unit 110 when they need not be distinguished from each other). Meanwhile, in FIG. 1A, only the leg units 110A and 110B are illustrated, but on a far side of the sheet of FIG. 1A, leg units that form pairs with the leg units 110A and 110B are arranged. In other words, the robot apparatus 100 is a four-legged walking robot including the four leg units 110.

The body unit 120 includes a control apparatus that entirely controls posture or the like of the robot apparatus 100, and is supported by the plurality of leg units 110. The control apparatus included in the body unit 120 may control posture of each of the leg units 110. For example, the control apparatus included in the body unit 120 may control drive of each of the leg units 110 in a cooperative manner on the basis of sensing information obtained from various sensors included in each of the leg units 110 and the sensor 130. Through the control performed by the control apparatus, the robot apparatus 100 is able to walk using the leg units 110.

The plurality of leg units 110 are mounted on the body unit 120 and support the body unit 120. For example, the leg unit 110A may include joints 113 and 115, links 112 and 114 that are rotatably connected to the joints 113 and 115, and a ground unit 111 that is arranged on a distal end of the link 112. The links 112 and 114 are connected to each other by the joint 113, and are also connected to the body unit 120 by the joint 115, so that a link structure is constructed. Meanwhile, all of the leg units 110 may be configured with the same link structure, or may be configured with different link structures.

Each of the joints 113 and 115 includes, for example, an actuator, an encoder for detecting a driving state of the actuator, a reducer for braking the actuator, a torque sensor for detecting torque applied to the links driven by the actuator, and the like. The control apparatus included in the body unit 120 is able to control the posture of the leg unit 110 by causing the actuator and the reducer to operate on the basis of a detection result obtained from the encoder or the torque sensor.

The sensor 130 acquires environmental information by observing a surrounding environment. The robot apparatus 100 is able to appropriately perform movement, such as walking, by controlling each of the leg units 110 on the basis of the environmental information acquired by the sensor 130.

Specifically, the sensor 130 is an object recognition sensor that is able to recognize a target object. For example, the sensor 130 may be various cameras, such as an RGB camera, a grayscale camera, a stereo camera, a depth camera, an infrared camera, or a time of flight (ToF) camera, or may be various distance measurement sensors, such as a laser imaging detection and ranging (LIDAR) sensor or a radio detecting and ranging (RADAR) sensor.

The technology according to the present disclosure is applicable to the legged robot apparatus 100 as described above. Specifically, the technology according to the present disclosure is to control a mode of acquisition or use of the environmental information that is acquired by the sensor 130 and that is used to control the leg unit 110, to thereby prevent control of the leg unit 110 from being influenced by an element, such as the leg unit 110, related to the robot apparatus 100. More specifically, the technology according to the present disclosure is to control the leg unit 110 while preventing an influence by an environmental element by acquiring the environmental information so as not to include a related element, such as the leg unit 110, of the robot apparatus 100 or by using information that does not include the related element, such as the leg unit 110, of the robot apparatus 100 in the environmental information. With this configuration, the technology according to the present disclosure is able to cause the robot apparatus 100 to more appropriately move by preventing the robot apparatus 100 from recognizing an element related to the robot apparatus 100 as a surrounding obstacle or the like.

However, the technology according to the present disclosure is similarly applicable to a robot apparatus that has a different configuration from the robot apparatus 100 illustrated in FIG. 1A.

For example, the technology according to the present disclosure is applicable to a robot apparatus 101 as illustrated in FIG. 1B. As illustrated in FIG. 1B, the robot apparatus 101 is different from the robot apparatus 100 illustrated in FIG. 1A in that it includes a plurality of sensors 131 and 132. The technology according to the present disclosure is able to appropriately control movement of the robot apparatus 101 by controlling a mode of acquisition or use of each piece of environmental information acquired by the plurality of sensors 131 and 132.

For example, the technology according to the present disclosure is also applicable to a robot apparatus 200 as illustrated in FIG. 2. As illustrated in FIG. 2, the robot apparatus 200 includes a body unit 220, a sensor 230, a leg unit 210, and an arm unit 240. Meanwhile, only the single leg unit 210 and the single arm unit 240 are illustrated in FIG. 2, but on the far side of the sheet of FIG. 2, a leg unit that forms a pair with the leg unit 210 and an arm unit that forms a pair with the arm unit 240 are arranged. In other words, the robot apparatus 200 is a humanoid robot including the two leg units and the two arm units.

For example, the leg unit 210 may include joints 213 and 215, links 212 and 214 that are rotatably connected to the joints 213 and 215, and a ground unit 211 that is arranged on a distal end of the link 212. For example, the arm unit 240 may include joints 243 and 245, links 242 and 244 that are rotatably connected to the joints 243 and 245, and an end effector 241 that is arranged on a distal end of the link 242. The robot apparatus 200 is able to control movement of the robot apparatus 200 while preventing an influence of an environmental element by controlling the mode of acquisition or use of the environmental information so as not to include the leg unit 210 or the arm unit 240 that is a related element of the robot apparatus 200.

In other words, the technology according to the present disclosure is applicable to a robot apparatus having any configuration as long as the robot apparatus moves on the basis of surrounding environmental information. In the following, the technology according to the present disclosure will be described using a first embodiment and a second embodiment.

### 2. First Embodiment

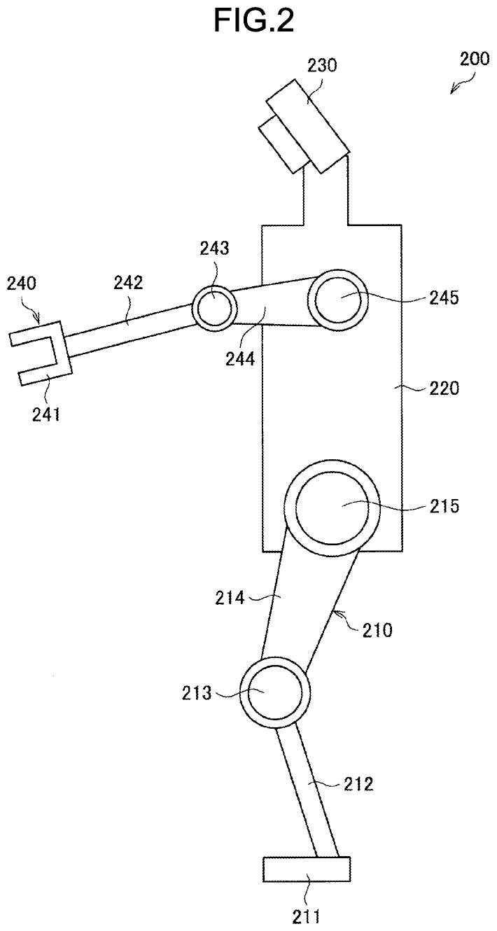

With reference to FIG. 3 to FIG. 9, a control apparatus according to a first embodiment that implements the technology according to the present disclosure will be described.

### 2.1. Configuration Example

First, a configuration example of a control apparatus 300 according to the present embodiment will be described with reference to FIG. 3. FIG. 3 is a block diagram for explaining a functional configuration of the control apparatus 300 according to the present embodiment.

As illustrated in FIG. 3, the control apparatus 300 includes a recognition unit 320 including an estimation unit 321, a determination unit 322, and an environmental information control unit 323, and further includes a model storage unit 330, a movement planning unit 340, and a drive control unit 350.

The control apparatus 300 generates a movement plan of the robot apparatus 100 on the basis of environmental information acquired by a sensor unit 310, and controls drive of a driving unit 360 that is included in the leg unit 110 or the like of the robot apparatus 100 on the basis of the generated movement plan. Accordingly, the control apparatus 300 is able to control movement of the robot apparatus 100. Meanwhile, the control apparatus 300 need not be provided inside the robot apparatus 100, but may be provided outside the robot apparatus 100.

The sensor unit 310 includes the sensor 130 that acquires the environmental information by observing a surrounding environment, and a sensor that measures a driving state of the driving unit 360. The sensor 130 that acquires the environmental information is, as described above, an object recognition sensor that is able to recognize a target object, and may be various cameras, such as an RGB camera, a grayscale camera, a stereo camera, a depth camera, an infrared camera, or a ToF camera, or may be various distance measurement sensors, such as a LIDAR sensor or a RADAR sensor. The sensor that measures the driving state of the driving unit 360 may be, for example, an encoder, a voltmeter, an ammeter, a distortion gauge, a gyro sensor, a torque sensor, an acceleration sensor, or an inertial measurement unit (IMU).

Here, the environmental information acquired by the sensor unit 310 is a captured image or a distance measured information that is obtained by sensing a certain region around the robot apparatus 100. The robot apparatus 100 is able to determine presence or absence of an obstacle around the robot apparatus 100 and appropriately move by referring to the environmental information acquired by the sensor unit 310.

Meanwhile, the sensor 130 that acquires the environmental information may be configured to be able to acquire environmental information on different regions. For example, the sensor 130 that acquires the environmental information may be configured to include a joint and a driving unit inside or outside of the sensor 130, and to be able to acquire environmental information on different regions by changing orientation of the sensor 130. Alternatively, the sensor 130 that acquires the environmental information may be configured such that a sensing region is divided into a plurality of regions and so as to be able to acquire environmental information for each of the divided regions. With this configuration, the sensor 130 that acquires the environmental information is able to acquire the environmental information so as not to include the related element by controlling a region from which the environmental information is acquired, as will be described later.

The model storage unit 330 stores therein a body model of the robot apparatus 100. The body model of the robot apparatus 100 is information for determining posture of the robot apparatus 100 on the basis of direct kinematics. The body model of the robot apparatus 100 may be, for example, information on a shape and a size of each of components included in the robot apparatus 100 and information on a connection relation, a speed reduction ratio, and the like among the components.

The estimation unit 321 estimates a position and a shape of the related element of the robot apparatus 100. Specifically, the estimation unit 321 estimates the positon and the shape of the related element of the robot apparatus 100 using the direct kinematics on the basis of the body model of the robot apparatus 100 stored in the model storage unit 330 and the driving state of the driving unit 360 measured by the sensor unit 310. For example, when estimating the position of the leg unit 110, the estimation unit 321 may estimate the position and the speed of the leg unit 110 on the basis of information on link lengths and speed reduction ratios of the links included in the leg unit 110 and encoder information on a motor that drives the joints included in the leg unit 110.

Here, the related element represents an element that is related to the robot apparatus 100 and that is driven by the robot apparatus 100. For example, the related element may be a component of the robot apparatus 100, such as the leg unit 110, the body unit 120, or the arm unit 240, or may be an object held by the arm unit 240.

Meanwhile, the estimation unit 321 may estimate the positions and the shapes of all of the components of the robot apparatus 100, or may estimate the position and the shape of a part of the components of the robot apparatus 100. Specifically, the estimation unit 321 may estimate the position and the shape of only a component that is likely to be included in the environmental information when the component is driven. Further, when whether the related element is included in the environmental information or not is determined by the driving state of a part of the driving unit 360 (for example, a rotation angle of a part of the joints or the like), the estimation unit 321 may estimate the driving state of the part of the driving unit 360. With this configuration, the control apparatus 300 is able to reduce a calculation load related to estimation performed by the estimation unit 321.

The determination unit 322 determines whether the environmental information acquired by the sensor unit 310 includes the related element on the basis of the estimation performed by the estimation unit 321. Specifically, the determination unit 322 determines whether the estimated related element is included in the sensing region of the sensor unit 310 that acquires the environmental information. For example, if the environmental information acquired by the sensor unit 310 is a captured image, the determination unit 322 may determine whether the leg unit 110 or the like of the robot apparatus 100 is included in the captured image. Meanwhile, the determination unit 322 may determine whether the environmental information includes the related element before the sensor unit 310 acquires the surrounding environmental information or after the sensor unit 310 acquires the surrounding environmental information.

Furthermore, as illustrated in FIG. 1B, if the plurality of sensors 130 that acquire the environmental information are provided, it is sufficient to determine whether the environmental information includes the related element with respect to only the sensor 130 that is likely to acquire the environmental information including the related element. With this configuration, even if the robot apparatus 101 includes the plurality of sensors 130, the control apparatus 300 is able to reduce a calculation load related to determination performed by the determination unit 322.

Moreover, if the environmental information includes the related element, the determination unit 322 may determine a region in which the related element is included in the environmental information. With this configuration, by causing the environmental information control unit 323 on the subsequent stage to eliminate a region including the related element from the environmental information acquired by the sensor unit 310, the control apparatus 300 is able to prevent the related element from being included in the environmental information.

The environmental information control unit 323 controls the mode of acquisition or use of the environmental information such that the related element is not included in the environmental information, on the basis of determination performed by the determination unit 322.

Specifically, if the determination unit 322 performs determination before acquisition of the environmental information, the environmental information control unit 323 may control the mode of acquisition of the environmental information on the basis of the determination performed by the determination unit 322. For example, the environmental information control unit 323 may control a timing at which the sensor unit 310 acquires the environmental information, on the basis of the determination performed by the determination unit 322. In other words, the environmental information control unit 323 may cause the sensor unit 310 to acquire the environmental information at a timing at which the related element is not included in the sensing region of the sensor unit 310. Alternatively, the environmental information control unit 323 may control a region in which the environmental information is acquired by the sensor unit 310, on the basis of the determination performed by the determination unit 322. In other words, the environmental information control unit 323 may control the sensing region of the sensor unit 310 such that the related element is not included.

Furthermore, if the determination unit 322 performs determination after acquisition of the environmental information, the environmental information control unit 323 may control the mode of use of the environmental information on the basis of the determination performed by the determination unit 322. For example, the environmental information control unit 323 may control whether to cause the movement planning unit 340 on the subsequent stage to use the environmental information acquired by the sensor unit 310, on the basis of the determination performed by the determination unit 322. In other words, if the environmental information includes the related element, the environmental information control unit 323 may prevent the environmental information including the related element from being used to generate the movement plan. Alternatively, the environmental information control unit 323 may control a use region in the environmental information acquired by the sensor unit 310, on the basis of the determination performed by the determination unit 322. In other words, the environmental information control unit 323 may prevent a region including the related element in the environmental information from being used to generate the movement plan.

With this configuration, the control apparatus 300 is able to use the environmental information, which does not include the related element, to generate the movement plan with a simpler structure, even without performing a process of identifying the related element from the acquired environmental information.

In particular, accuracy of estimation of the position and the shape of the related element based on the body model or the like of the robot apparatus 100 is low because there is an error between the body model of the robot apparatus 100 and an actual mechanism. Therefore, even if the related element is identified from the environmental information on the basis of the body model or the like of the robot apparatus 100 and the related element is eliminated, in some cases, it is difficult to completely eliminate the related element from the environmental information. The control apparatus 300 according to the present embodiment, by controlling the mode of acquisition or use of the environmental information, is able to use the environmental information, which does not include the related element, to generate the movement plan without performing complicated information processing. Therefore, the control apparatus 300 is able to reduce a load related to the information processing at the time of generating the movement plan.

The movement planning unit 340 generates a behavior plane of the robot apparatus 100 on the basis of the acquired environmental information. Specifically, the movement planning unit 340 generates a movement plan for controlling the postures of the robot apparatus 100 on the basis of the environmental information that is controlled so as not to include the related element by the environmental information control unit 323 and on the basis of apparatus information on the robot apparatus 100. With this configuration, the movement planning unit 340 is able to generate an appropriate movement plan without erroneously recognizing a component of the subject apparatus as an obstacle or the like. Meanwhile, the apparatus information on the robot apparatus 100 is information that is acquired by a sensor that measures a state of the robot apparatus 100 in the sensor unit 310, for example.

The drive control unit 350 controls drive of the driving unit 360 so as to cause the robot apparatus 100 to perform desired movement, on the basis of the movement plan generated by the movement planning unit 340 and the apparatus information on the robot apparatus 100. Specifically, the drive control unit 350 may cause the robot apparatus 100 to perform desired movement by controlling the drive of the driving unit 360 such that a difference between a state planed by the movement plan and a current state of the robot apparatus 100 is reduced.

The driving unit 360 drives each of the movement units (for example, the leg unit 110, the arm unit 240, or the like) of the robot apparatus 100 under the control of the drive control unit 350. For example, the driving unit 360 may be an actuator that drives the joints of the leg unit 110 or the arm unit 240 of the robot apparatus 100.

### 2.2. Operation Example

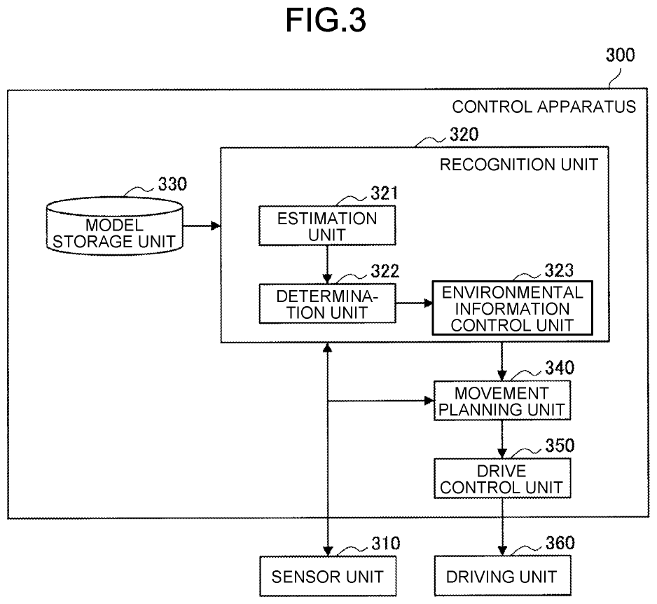

Next, operation examples of the control apparatus 300 according to the present embodiment will be described with reference to FIG. 4 to FIG. 9. FIG. 4 to FIG. 9 are flowcharts for explaining the flows of first to six operation examples of the control apparatus 300 according to the present embodiment.

### First Operation Example

The first operation example for which the flow is illustrated in FIG. 4 is an operation example in which whether the environmental information includes the related element is determined before acquisition of the environmental information.

As illustrated in FIG. 4, in the first operation example, first, the estimation unit 321 estimates the position and the shape of the related element on the basis of the body model of the robot apparatus 100 and the driving state of the driving unit 360 (S101). Thereafter, the determination unit 322 determines whether the estimated related element is included in the sensing region of the sensor unit 310 (S102).

Here, if it is determined that the related element is not included in the sensing region of the sensor unit 310 (S102/No), the sensor unit 310 acquires the environmental information (S103), and the movement planning unit 340 generates the movement plan on the basis of the acquired environmental information that does not include the related element (S104). In contrast, if it is determined that the related element is included in the sensing region of the sensor unit 310 (S102/Yes), the sensor unit 310 does not acquire the environmental information, and estimation of the position and the shape of the related element at Step S101 is performed again.

According to the first operation example, the environmental information acquired by the sensor unit 310 does not include the related element (the leg unit 110 or the like) of the robot apparatus 100. Therefore, the control apparatus 300 is able to use the environmental information to generate the movement plan without performing the information processing for eliminating the related element from the environmental information.

### Second Operation Example

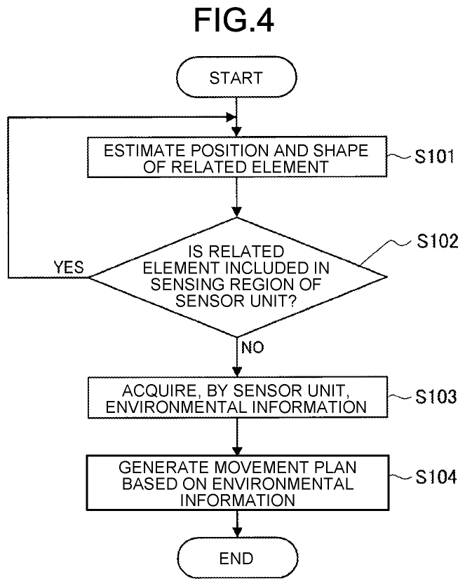

The second operation example for which the flow is illustrated in FIG. 5 is an operation example in which an exception process, which is performed when a state in which the environmental information includes the related element is continued for a long time, is added to the first operation example.

As illustrated in FIG. 5, in the second operation example, similarly to the first operation example, the estimation unit 321 estimates the position and the shape of the related element on the basis of the body model of the robot apparatus 100 and the driving state of the driving unit 360 (S111). Thereafter, the determination unit 322 determines whether the estimated related element is included in the sensing region of the sensor unit 310 (S112).

Here, if it is determined that the related element is not included in the sensing region of the sensor unit 310 (S112/No), the sensor unit 310 acquires the environmental information (S113), and the movement planning unit 340 generates the movement plan on the basis of the acquired environmental information that does not include the related element (S114).

In contrast, if it is determined that the related element is included in the sensing region of the sensor unit 310 (S112/Yes), it is further determined whether a state in which the environmental information is not acquired is continued for a predetermined time (S115). If the state in which the environmental information is not acquired is not continued for the predetermined time (S115/No), the estimation unit 321 estimates the position and the shape of the related element again at Step S111.

If the state in which the environmental information is not acquired is continued for the predetermined time (S115/Yes), the control apparatus 300 causes the sensor unit 310 to acquire the environmental information (S116). The environmental information acquired at this time includes the related element, and therefore, the control apparatus 300 performs information processing for eliminating the related element included in the environmental information (S117). Thereafter, the movement planning unit 340 generates the movement plan on the basis of the environmental information that is subjected to the information processing so as not to include the related element (S114).

According to the second operation example, it is possible to avoid a situation in which the estimated related element is included in the sensing region of the sensor unit 310 and it is difficult to acquire the environmental information for a long time. Therefore, according to the second operation example, even if the related element is highly frequently included in the sensing region of the sensor unit 310, it is possible to smoothly generate the movement plan.

### Third Operation Example

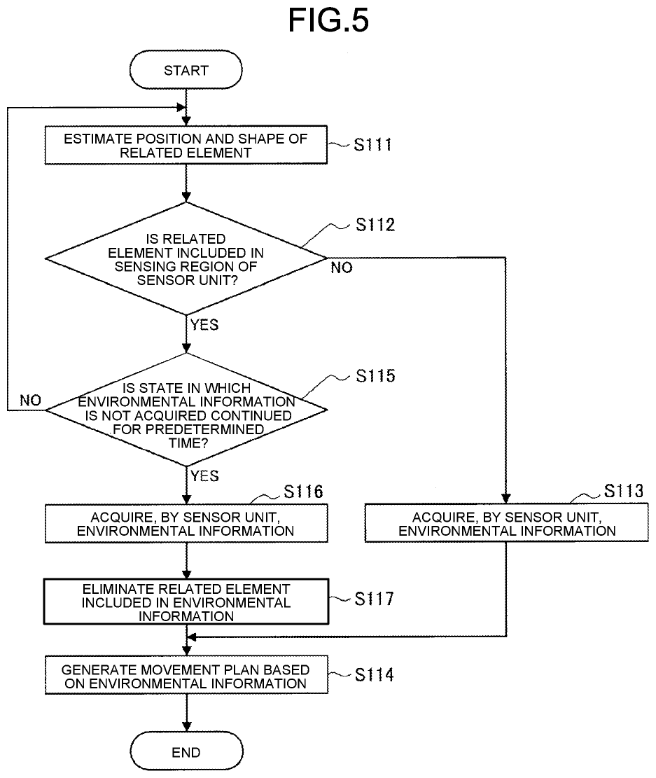

The third operation example for which the flow is illustrated in FIG. 6 is an operation example in which, unlike the first operation example, the environmental information that does not include the related element is acquired by causing the sensor unit 310 to control a region in which the environmental information is to be acquired. In the third operation example, the sensor unit 310 is configured to be able to acquire environmental information on a plurality of regions, and is caused to acquire environmental information on a region in which the related element is not included.

As illustrated in FIG. 6, in the third operation example, first, the estimation unit 321 estimates the position and the shape of the related element on the basis of the body model of the robot apparatus 100 and the driving state of the driving unit 360 (S121). Thereafter, the determination unit 322 determines a region in which the related element is included among sensing regions in which the sensor unit 310 is able to acquire the environmental information (S122). Subsequently, the sensor unit 310 acquires the environmental information on a region in which the related element is not included (S123), and the movement planning unit 340 generates the movement plan on the basis of the acquired environmental information that does not include the related element (S124).

According to the third operation example, the environmental information acquired by the sensor unit 310 does not include the related element (the leg unit 110 or the like) of the robot apparatus 100. Therefore, the control apparatus 300 is able to use the environmental information to generate the movement plan without performing the information processing for eliminating the related element from the environmental information. For example, if the related element is the leg unit 110, the leg units 110 on the left and right sides viewed in the moving direction of the robot apparatus 100 are alternately put forward. Therefore, by setting a region opposite to the side on which the leg unit 110 is put forward as the region in which the environmental information is to be acquired, the sensor unit 310 is able to more easily acquire the environmental information that does not include the leg unit 110.

### Fourth Operation Example

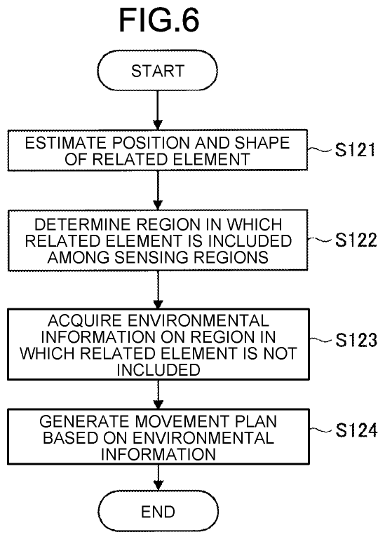

The fourth operation example for which the flow is illustrated in FIG. 7 is an operation example in which whether the environmental information includes the related element is determined after acquisition of the environmental information.

As illustrated in FIG. 7, in the fourth operation example, first, the sensor unit 310 acquires the environmental information (S201). Subsequently, the estimation unit 321 estimates the position and the shape of the related element on the basis of the body model of the robot apparatus 100 and the driving state of the driving unit 360 (S202). Thereafter, the determination unit 322 determines whether the estimated related element is included in the sensing region of the sensor unit 310 (S203).

Here, if it is determined that the related element is not included in the sensing region of the sensor unit 310 (S203/No), the movement planning unit 340 generates the movement plan on the basis of the acquired environmental information that does not include the related element (S204). In contrast, if it is determined that the related element is included in the sensing region of the sensor unit 310 (S203/Yes), the control apparatus 300 returns to Step S201 and acquires the environmental information again.

According to the fourth operation example, the environmental information used to generate the movement plan does not include the related element (the leg unit 110 or the like) of the robot apparatus 100. Therefore, the control apparatus 300 is able to generate the movement plan without performing the information processing for eliminating the related element from the environmental information.

### Fifth Operation Example

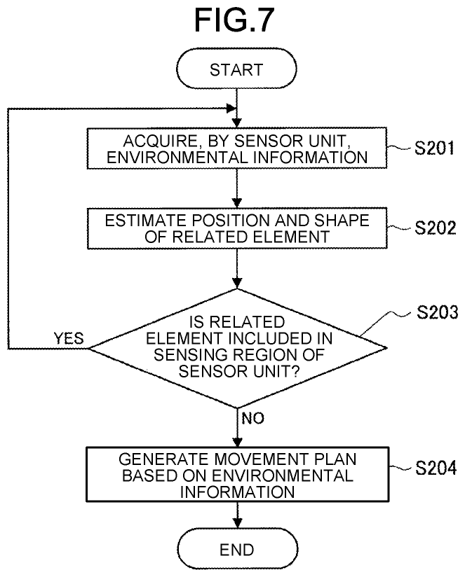

The fifth operation example for which the flow is illustrated in FIG. 8 is an operation example in which an exception process, which is performed when a state in which the environmental information includes the related element is continued for a long time, is added to the fourth operation example.

As illustrated in FIG. 8, in the fifth operation example, similarly to the fourth operation example, first, the sensor unit 310 acquires the environmental information (S211). Subsequently, the estimation unit 321 estimates the position and the shape of the related element on the basis of the body model of the robot apparatus 100 and the driving state of the driving unit 360 (S212). Thereafter, the determination unit 322 determines whether the estimated related element is included in the sensing region of the sensor unit 310 (S213).

Here, if it is determined that the related element is included in the sensing region of the sensor unit 310 (S213/No), the movement planning unit 340 generates the movement plan on the basis of the acquired environmental information that does not include the related element (S214).

In contrast, if it is determined that the related element is included in the environmental information (S213/Yes), it is further determined whether a state in which the environmental information includes the related element is continued for a predetermined time (S215). If the state in which the environmental information includes the related element is not continued for the predetermined time (S215/No), the sensor unit 310 acquires the environmental information again at Step S211.

If the state in which the environmental information includes the related element is continued for the predetermined time (S215/Yes), the control apparatus 300 performs the information processing for eliminating the related element included in the environmental information (S216). Thereafter, the movement planning unit 340 generates the movement plan on the basis of the environmental information that is subjected to the information processing so as not to include the related element (S214).

According to the fifth operation example, even if the related element is highly frequently included in the sensing region of the sensor unit 310, it is possible to smoothly generate the movement plan.

### Sixth Operation Example

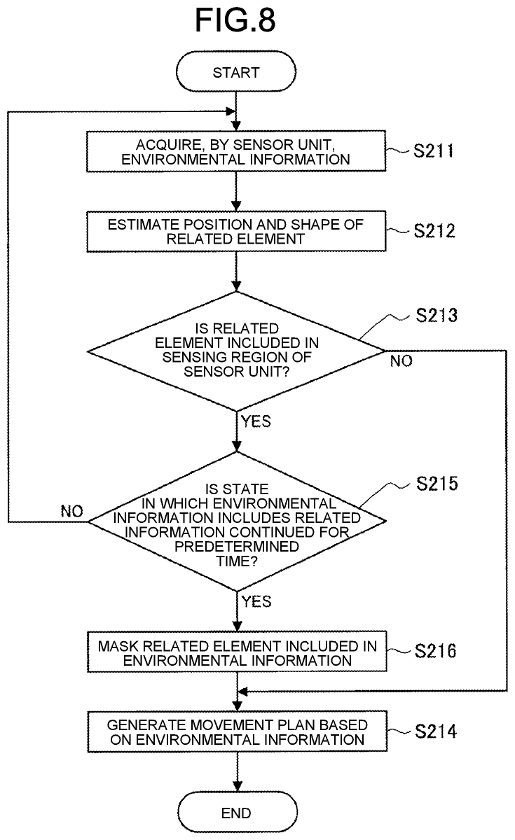

The sixth operation example for which the flow is illustrated in FIG. 9 is an operation example in which, unlike the fourth operation example, the movement plan is generated by the environmental information that does not include the related element by controlling a region of the environmental information used to generate the movement plan.

As illustrated in FIG. 9, in the sixth operation example, first, the sensor unit 310 acquires the environmental information (S221). Subsequently, the estimation unit 321 estimates the position and the shape of the related element on the basis of the body model of the robot apparatus 100 and the driving state of the driving unit 360 (S222). Thereafter, the determination unit 322 determines a region in which the related element is included among regions in the environmental information (S223). Subsequently, environmental information on a region in which the related element is not included is extracted from the environmental information (S224). Then, the movement planning unit 340 generates the movement plan on the basis of the extracted environmental information on the region in which the related element is not included (S225).

According to the sixth operation example, the environmental information used to generate the movement plan does not include the related element (the leg unit 110 or the like) of the robot apparatus 100. Therefore, the control apparatus 300 is able to generate the movement plan without performing the information processing for eliminating the related element from the environmental information. For example, if the related element is the leg unit 110, the leg units 110 on the left and right sides viewed in the moving direction of the robot apparatus 100 are alternately put forward. Therefore, by setting a region opposite to the side on which the leg unit 110 is put forward as the region of the environmental information that is used to generate the movement plan, the movement planning unit 340 is able to generate the movement plan by using the environmental information that does not include the leg unit 110.

### 3. Second Embodiment

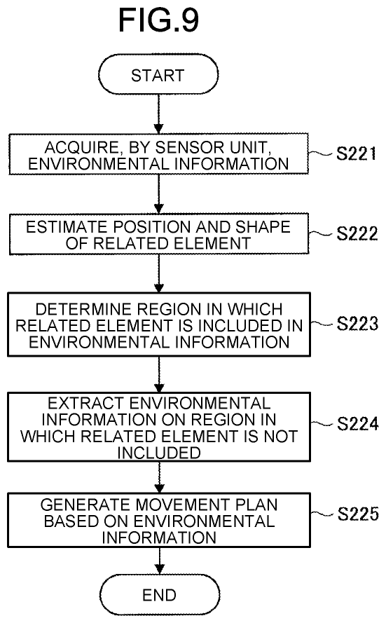

Next, a control apparatus 400 according to a second embodiment that implements the technology according to the present disclosure will be described with reference to FIG. 10 to FIG. 12. The technology according to the second embodiment is applicable to the robot apparatus 100 independent of the technology according to the first embodiment. However, it is obvious that the technology according to the second embodiment may be applied to the robot apparatus 100 in combination with the technology according to the first embodiment.

### 3.1. Configuration Example

First, a configuration example of the control apparatus 400 according to the present embodiment will be described with reference to FIG. 10. FIG. 10 is a block diagram for explaining a functional configuration of the control apparatus 400 according to the present embodiment.

As illustrated in FIG. 10, the control apparatus 400 includes an image processing unit 420, a movement planning unit 440, and a drive control unit 450.

The control apparatus 400 identifies, from the environmental information acquired by a sensor unit 410, a region corresponding to the related element on the basis of the predetermined pattern, and eliminates the identified region from the environmental information through image processing. With this configuration, the control apparatus 400 is able to generate a movement plan for driving a driving unit 460 by using the environmental information from which the related element is eliminated.

Meanwhile, the configurations of the sensor unit 410, the movement planning unit 440, the drive control unit 450, and the driving unit 460 are substantially the same as the configurations of the sensor unit 310, the movement planning unit 340, the drive control unit 350, and the driving unit 360 illustrated in FIG. 3, and therefore, explanation thereof will be omitted.

The image processing unit 420 identifies a region corresponding to the related element from the environmental information on the basis of a predetermined pattern, and eliminates the identified region from the environmental information.

Here, the predetermined pattern is a pattern or the like for distinguishing between the region corresponding to the related element and other regions.

Specifically, if the sensor 130 that acquires the environmental information is a visible-light imaging apparatus, the predetermined pattern may be an artificial or a geometrical pattern or a color that is arranged on a surface of the related element and that can hardly be included in the environmental information. In this case, the image processing unit 420 is able to determine a certain region, in which the predetermined pattern (for example, a fluorescence color, strips, dots, or the like) that is arranged on the surface of the related element is recognized, as the region corresponding to the related element.

Furthermore, if the sensor 130 that acquires the environmental information is an active sensor that applies light or oscillatory waves to a target object and detects reflection from the applied target object to thereby acquire surrounding environmental information, the predetermined pattern may be a light pattern or an oscillatory-wave pattern that is different from a pattern of irradiation from the sensor 130. Meanwhile, the oscillatory waves represent oscillation that propagates through air, and, for example, the oscillatory waves may include sound or ultrasound waves.

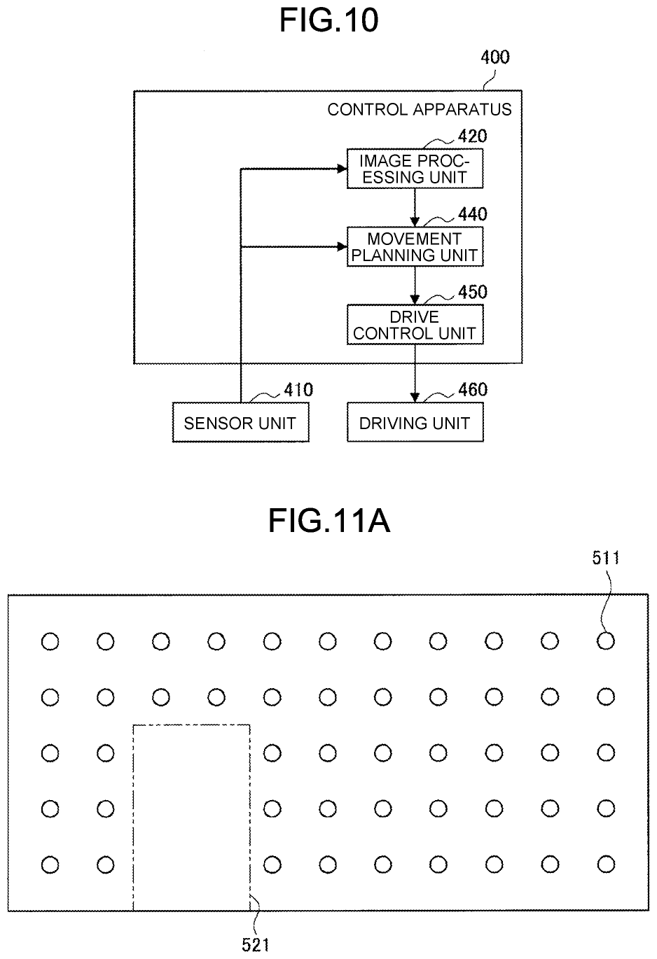

Specifically, if the surface of the related element is processed to absorb the applied light or oscillatory waves, the predetermined pattern is a non-reflective pattern in which the applied light or oscillatory waves is/are not detected. For example, as illustrated in FIG. 11A, if the sensor 130 that acquires the environmental information is an infrared sensor that applies infrared 511 in a regularly-dotted pattern, the related element having a surface that is processed to absorb the applied infrared is recognized, by the sensor 130, as a non-reflective pattern 521 in which the infrared is not detected. Therefore, the image processing unit 420 is able to determine the region of the non-reflective pattern 521 in which the infrared is not detected as the region corresponding to the related element.

Furthermore, if the surface of the related element is processed to emit applied light or oscillatory waves, the predetermined pattern is a pattern of light or oscillatory waves emitted from the related element. For example, as illustrated in FIG. 11B, if the sensor 130 that acquires the environmental information is an infrared sensor that applies infrared 512 in a regularly-dotted pattern, the related element that is processed to uniformly emit infrared is recognized, by the sensor 130, as a fill pattern 522 in which the infrared is uniformly detected. Therefore, the image processing unit 420 is able to determine the region of the fill pattern 522 in which the infrared is uniformly detected as the region corresponding to the related element.

With this configuration, the image processing unit 420 is able to identify the related element in the environmental information through a simpler process, so that it is possible to reduce a load related to calculations.

### 3.2. Operation Example

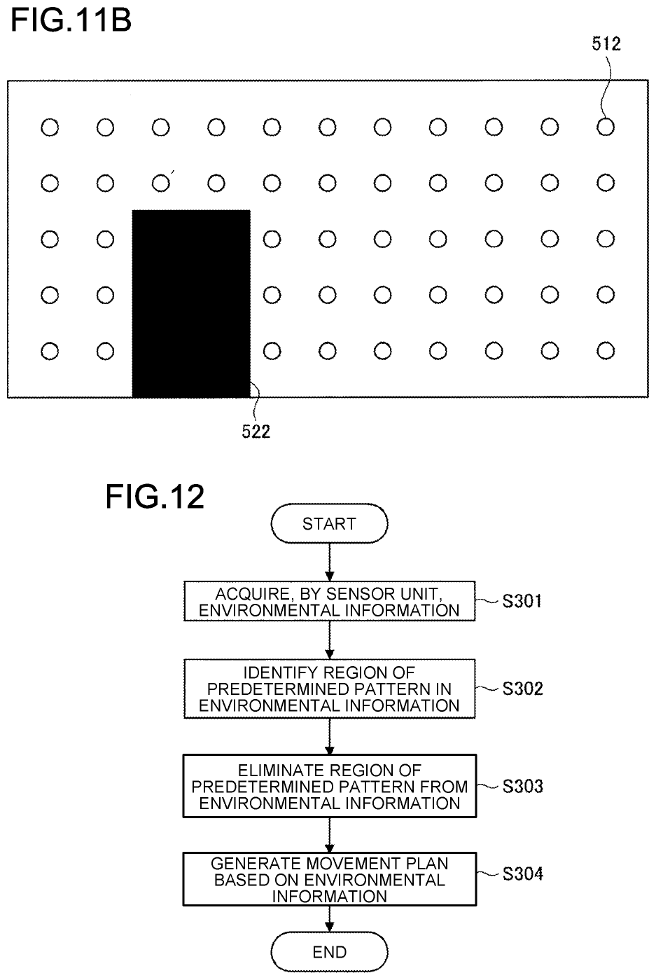

Next, an operation example of the control apparatus 400 according to the present embodiment will be described with reference to FIG. 12. FIG. 12 is a flowchart for explaining the flow of the operation example of the control apparatus 400 according to the present embodiment.

As illustrated in FIG. 12, first, the sensor unit 410 acquires the environmental information (S301). The sensor unit 410 may be a visible-light imaging apparatus or a distance measurement sensor that measures a distance to a target object by applying infrared to the target object and detecting reflected light of the applied infrared, for example. Subsequently, the image processing unit 420 identifies a region of the predetermined pattern corresponding to the related element from the environmental information (S302). Then, the image processing unit 420 eliminates the identified predetermined pattern from the environmental information (S303). Thereafter, the movement planning unit 440 generates the movement plan by using the environmental information from which the region corresponding to the related element is eliminated (S304).

According to the operation example as described above, the control apparatus 400 according to the present embodiment is able to reduce a calculation load related to generation of the movement plan.

### 4. Hardware Configuration Example

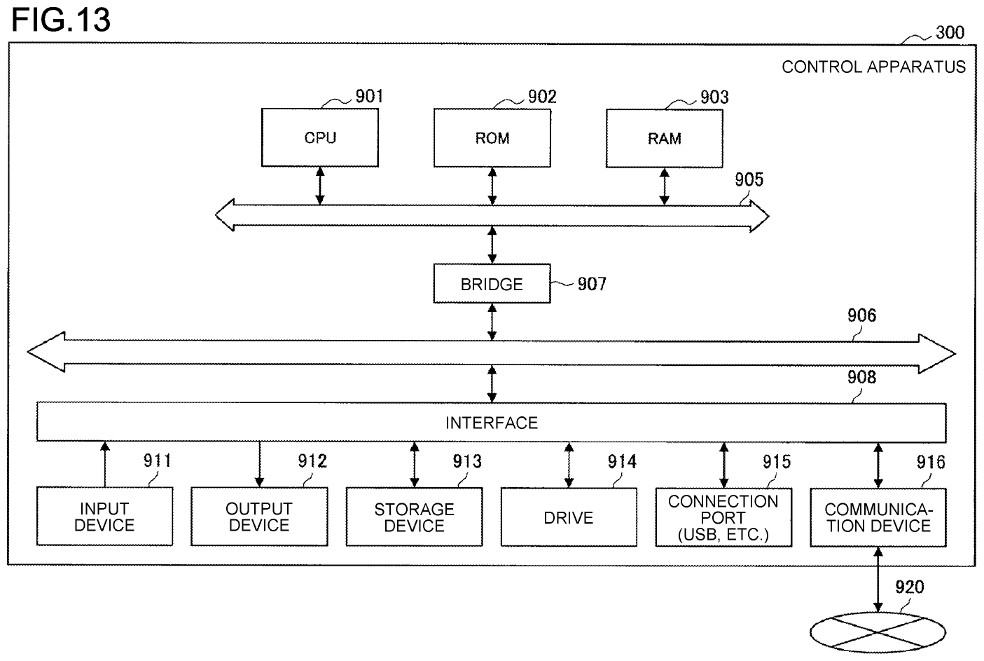

Next, a hardware configuration of the control apparatus 300 according to the first embodiment of the present disclosure will be described with reference to FIG. 13. FIG. 13 is a block diagram illustrating a hardware configuration example of the control apparatus 300 according to the present embodiment. Meanwhile, the control apparatus 400 according to the second embodiment of the present disclosure can be realized by the same hardware configuration.

As illustrated in FIG. 13, the control apparatus 300 includes a central processing unit (CPU) 901, a read only memory (ROM) 902, a random access memory (RAM) 903, a bridge 907, internal buses 905 and 906, an interface 908, an input device 911, an output device 912, a storage device 913, a drive 914, a connection port 915, and a communication device 916.

The CPU 901 functions as an arithmetic processing device, and controls the entire operation of the control apparatus 300 in accordance with various programs stored in the ROM 902 or the like. The ROM 902 stores therein programs and arithmetic parameters used by the CPU 901, and the RAM 903 temporarily stores therein programs used during execution of the CPU 901, parameters that are appropriately changed during the execution, and the like. For example, the CPU 901 may implement the functions of the recognition unit 320, the image processing unit 420, the movement planning units 340 and 440, and the drive control units 350 and 450.

The CPU 901, the ROM 902, and the RAM 903 are connected to each other by the bridge 907, the internal buses 905 and 906, and the like. Further, the CPU 901, the ROM 902, and the RAM 903 are also connected to the input device 911, the output device 912, the storage device 913, the drive 914, the connection port 915, and the communication device 916 via the interface 908.

The input device 911 includes an input device, such as a touch panel, a keyboard, a mouse, a button, a microphone, a switch, and a lever, by which information is input. Further, the input device 911 includes an input control circuit for generating an input signal based on the input information and outputting the input signal to the CPU 901.

The output device 912 includes, for example, a display device, such as a cathode ray tube (CRT) display device, a liquid crystal display device, and an organic electroluminescence (EL) display device. Further, the output device 912 may include a voice output device, such as a speaker and a headphone.

The storage device 913 is a storage device for storing data of the control apparatus 300. The storage device 913 may include a storage medium, a storage device that stores data in the storage medium, a reading device that reads data from the storage medium, and a deleting device that deletes stored data. For example, the storage device 913 may implement the functions of the model storage unit 330.

The drive 914 is a reader-writer for a storage medium, and is incorporated in or externally attached to the control apparatus 300. For example, the drive 914 reads information that is stored in an attached removable storage medium, such as a magnetic disk, an optical disk, or a semiconductor memory, and outputs the information to the RAM 903. The drive 914 is able to write information to the removable storage medium.

The connection port 915 is, for example, a connection interface including a connection port, such as a universal serial bus (USB) port, an Ethernet (registered trademark) port, a port compliant with IEEE802.11, or an optical audio terminal, for connecting an external connection device.

The communication device 916 is, for example, a communication interface configured with a communication device or the like for establishing a connection to a network 920. Further, the communication device 916 may be a communication device compatible with a wired LAN or a wireless LAN, or a cable communication device that performs cable communication in a wired manner.

Meanwhile, it is possible to generate a computer program for implementing the same functions as those of each of the components of the control apparatus 300 as described above, with respect to hardware, such as the CPU, the ROM, and the RAM, included in the control apparatus 300. Furthermore, it is possible to provide a storage medium that stores therein the computer program.

### 5. Note

While the preferred embodiments of the present disclosure have been described in detail above with reference to the accompanying drawings, the technical scope of the present disclosure is not limited to the examples as described above. It is obvious that a person skilled in the technical field of the present disclosure may conceive various alternations and modifications within the scope of the appended claims, and it should be understood that they will naturally come under the technical scope of the present disclosure.

For example, the control apparatus 300 generates the movement plan while preventing the related element from being included in the environmental information in the embodiments as described above, but the technology according to the present disclosure is not limited to this example. For example, the control apparatus 300 may generate the movement plan while always causing the related element to be included in the environmental information. In this case, the control apparatus 300 is able to identify the related element in the environmental information based on the assumption that the environmental information includes the related element, so that it is possible to reduce a calculation load as compared to a case in which whether the environmental information includes the related element is not clear.

Further, the effects described in this specification are merely illustrative or exemplified effects, and are not limitative. That is, with or in the place of the above effects, the technology according to the present disclosure may achieve other effects that are clear to those skilled in the art from the description of this specification.

In addition, the following configurations are also within the technical scope of the present disclosure.

(1)

A control apparatus comprising:

a determination unit that determines whether a related element is included in environmental information on the basis of a position and a shape of the related element; and

an environmental information control unit that controls a mode of acquisition or use of the environmental information on the basis of determination performed by the determination unit.

(2)

The control apparatus according to (1), wherein the environmental information control unit controls a timing to acquire the environmental information.

(3)

The control apparatus according to (1), wherein the environmental information control unit controls a region in which the environmental information is acquired.

(4)

The control apparatus according to (2) or (3), wherein the environmental information control unit controls a mode of acquisition of the environmental information so as to acquire the environmental information that does not include the related element.

(5)

The control apparatus according to (1), further comprising:

a movement planning unit that generates a movement plan of a robot apparatus on the basis of the environmental information.

(6)

The control apparatus according to (5), wherein the environmental information control unit controls whether to use the environmental information to generate the movement plan.

(7)

The control apparatus according to (5), wherein the environmental information control unit controls a part of the environmental information used to generate the movement plan.

(8)

The control apparatus according to (6) or (7), wherein the environmental information control unit controls a mode of use of the environmental information such that the environmental information that does not include the related element is used to generate the movement plan.

(9)

The control apparatus according to any one of (5) to (8), further comprising:

a drive control unit that controls movement of the robot apparatus on the basis of the movement plan.

(10)

The control apparatus according to any one of (5) to (9), wherein the related element is a component of the robot apparatus.

(11)

The control apparatus according to (10), further comprising:

an estimation unit that estimates the position and the shape of the related element.

(12)

The control apparatus according to (11), wherein the estimation unit estimates the position and the shape of the related element that is likely to be included in the environmental information among related elements included in the robot apparatus.

(13)

The control apparatus according to (11) or (12), wherein the related element includes a joint section of the robot apparatus, and the estimation unit estimates a position and a shape of the joint section.

(14)

The control apparatus according to any one of (10) to

(13), wherein the robot apparatus is a legged robot apparatus, and the related element is a leg unit of the robot apparatus.
(15)

The control apparatus according to any one of (1) to (14), wherein the environmental information is acquired by an object recognition sensor that recognizes a target object.

(16)

The control apparatus according to any one of (1) to (15), wherein the environmental information control unit controls a mode of acquisition or use of the environmental information so as to acquire or use the environmental information that includes the related element.

(17)

The control apparatus according to (16), wherein

the environmental information is information on an image including the related element,

the control apparatus further comprising:

an image processing unit that determines a region corresponding to the related element from the environmental information on the basis of a predetermined pattern, and eliminates the region.

(18)

The control apparatus according to (17), wherein the image is one of a captured image of visible light and a captured image of infrared light that is reflected by a target object.

(19)

A control method implemented by an arithmetic device, the control method comprising:

determining whether a related element is included in environmental information on the basis of a position and a shape of the related element; and

controlling a mode of acquisition or use of the environmental information on the basis of determination at the determining.

(20)

A program that causes a computer to function as:

a determination unit that determines whether a related element is included in environmental information on the basis of a position and a shape of the related element; and

an environmental information control unit that controls a mode of acquisition or use of the environmental information on the basis of determination performed by the determination unit.

### REFERENCE SIGNS LIST

100, 101, 200 robot apparatus
110, 110A, 110B, 210 leg unit
120, 220 body unit
130, 131, 132, 230 sensor
240 arm unit
300, 400 control apparatus
310, 410 sensor unit
320 recognition unit
321 estimation unit
322 determination unit
323 environmental information control unit
330 model storage unit
340, 440 movement planning unit
350, 450 drive control unit
360, 460 driving unit
420 image processing unit

1. A control apparatus comprising:
a determination unit that determines whether a related element is included in environmental information on the basis of a position and a shape of the related element; and
an environmental information control unit that controls a mode of acquisition or use of the environmental information on the basis of determination performed by the determination unit.

2. The control apparatus according to claim 1, wherein the environmental information control unit controls a timing to acquire the environmental information.

3. The control apparatus according to claim 1, wherein the environmental information control unit controls a region in which the environmental information is acquired.

4. The control apparatus according to claim 2, wherein the environmental information control unit controls a mode of acquisition of the environmental information so as to acquire the environmental information that does not include the related element.

5. The control apparatus according to claim 1, further comprising:
a movement planning unit that generates a movement plan of a robot apparatus on the basis of the environmental information.

6. The control apparatus according to claim 5, wherein the environmental information control unit controls whether to use the environmental information to generate the movement plan.

7. The control apparatus according to claim 5, wherein the environmental information control unit controls a part of the environmental information used to generate the movement plan.

8. The control apparatus according to claim 6, wherein the environmental information control unit controls a mode of use of the environmental information such that the environmental information that does not include the related element is used to generate the movement plan.

9. The control apparatus according to claim 5, further comprising:
a drive control unit that controls movement of the robot apparatus on the basis of the movement plan.

10. The control apparatus according to claim 5, wherein the related element is a component of the robot apparatus.

11. The control apparatus according to claim 10, further comprising:
an estimation unit that estimates the position and the shape of the related element.

12. The control apparatus according to claim 11, wherein the estimation unit estimates the position and the shape of the related element that is likely to be included in the environmental information among related elements included in the robot apparatus.

13. The control apparatus according to claim 11, wherein
the related element includes a joint section of the robot apparatus, and
the estimation unit estimates a position and a shape of the joint section.

14. The control apparatus according to claim 10, wherein
the robot apparatus is a legged robot apparatus, and
the related element is a leg unit of the robot apparatus.

15. The control apparatus according to claim 1, wherein the environmental information is acquired by an object recognition sensor that recognizes a target object.

16. The control apparatus according to claim 1, wherein the environmental information control unit controls a mode of acquisition or use of the environmental information so as to acquire or use the environmental information that includes the related element.

17. The control apparatus according to claim 16, wherein
the environmental information is information on an image including the related element,
the control apparatus further comprising:
an image processing unit that determines a region corresponding to the related element from the environmental information on the basis of a predetermined pattern, and eliminates the region.

18. The control apparatus according to claim 17, wherein the image is one of a captured image of visible light and a captured image of infrared light that is reflected by a target object.

19. A control method implemented by an arithmetic device, the control method comprising:
determining whether a related element is included in environmental information on the basis of a position and a shape of the related element; and
controlling a mode of acquisition or use of the environmental information on the basis of determination at the determining.

20. A program that causes a computer to function as:
a determination unit that determines whether a related element is included in environmental information on the basis of a position and a shape of the related element; and
an environmental information control unit that controls a mode of acquisition or use of the environmental information on the basis of determination performed by the determination unit.
